(19) United States
(12) Patent Application Publication
(10) Pub. No.: US 2019/0279031 A1
(43) Pub. Date: Sep. 12, 2019

(54) METHOD AND SYSTEM FOR REPLACING A PROCESSING ENGINE

(71) Applicant: RES SOFTWARE DEVELOPMENT B.V., 'S-Hertogenbosch (NL)

(72) Inventors: Bob JANSSEN, Breda (NL); Reinhard Peter BRONGERS, Breda (NL)

(73) Assignee: RES SOFTWARE DEVELOPMENT B.V., 'S-Hertogenbosch (NL)

(21) Appl. No.: 16/324,826

(22) PCT Filed: Jun. 20, 2016
(86) PCT No.: PCT/EP2016/064187

§ 371 Date: Feb. 11, 2019

(51) Int. Cl. G06K 9/62; G06F 17/50; G06N 5/04

(52) U.S. Cl. CPC G06K 9/6231; G06N 5/04; G06F 17/5009

(57) ABSTRACT

The invention relates to a method of replacing a processing engine in which a first processing engine (25) is replaced with a second processing engine (28) if the first output (26) of the first processing engine (25) and the second output (29) of the second processing engine (28) are determined to be sufficiently similar. The second processing engine (28) is nm in a simulation mode. The first processing engine (25) is run in a production mode or in a simulation mode. Both processing engines use the same data set (21) as input.

### FIELD OF THE INVENTION

The invention relates to a method of replacing a processing engine, e.g. of an expert system.

The invention further relates to a system for replacing a processing engine.

The invention also relates to a computer program product enabling a computer system to perform such a method.

### BACKGROUND OF THE INVENTION

An example of such a processing engine is described in WO2008/119385 A1. WO2008/119385 A1 discloses a method and system for determining one or more valid entitlements for one or more persons or roles to one or more resources of an organization using an inference (processing) engine. Normally, a processing engine like this inference engine or of another type of expert system, is tested during development (in a lab environment) against staged data sets and rules of which the developer hopes that they are representative of actual data sets and rules that are going to be used by the processing engine when deployed/taken in production. Based on the outcome of the tests, a previous version of the processing engine in production is either replaced or not replaced with the processing engine that has been tested.

A drawback of the existing method of replacing a processing engine is that it takes a lot of effort to make staged data sets that are sufficiently representative of actual data sets and rules that are going to be used by the processing engine when taken in production, especially with the intricate and complex processing engines and rules that are common nowadays.

### SUMMARY OF THE INVENTION

It is a first object of the invention to provide a method of replacing a processing engine, which only replaces an old version of a processing engine with a new version of a processing engine when the new version performs well and which takes relatively little effort to perform.

It is a second object of the invention to provide a system for replacing a processing engine, which only replaces an old version of a processing engine with a new version of a processing engine when the new version performs well and which takes relatively little effort to configure.

According to the invention, the first object is realized in that the method of replacing a processing engine comprises the steps of a) a processor executing a first processing engine using a data set as input, said first processing engine having been deployed, b) a processor executing a second processing engine in a simulation mode using said data set as input, c) a processor comparing first output of said first processing engine using said data set as input with second output of said second processing engine using said data set as input, and d) a processor replacing said first processing engine with said second processing engine as deployed processing engine in dependence on at least said comparison. Said method may be performed by software running on a programmable device. This software may be provided as a computer program product. The processing engine may be the engine of an expert system, for example. The processing engine may comprise an algorithm, for example. A processing engine may be deployed by switching it to a production mode in which it can be used normally, i.e. not just for test purposes, by its users.

By checking in a production environment if an improved processing engine with the then in use data set yields the same outcome as the currently live/deployed version of the processing engine, i.e. the processing engine in production mode, it is ensured that there are no immediate/apparent issues or consequences when starting to use the improved processing engine. Staged data sets are not necessary in this case and it therefore takes relatively little effort to perform the method. The first processing engine may be replaced with the second processing engine as deployed processing engine, for example, when the outputs exactly match, when the outputs are different up to a certain degree or when an operator indicates that the differences between the outputs are not significant, e.g. using interaction with a screen.

Step a may comprise said processor executing said first processing engine using said data set as input in a production mode. When the data set used by the first processing engine does not change while the first processing engine is executing in production mode and the output generated by the first processing engine is accessible outside the production environment, this output can be used as the first output and be compared with the second output. This has as advantage that no additional resources are taken up to execute the first processing engine in simulation mode.

Step a may comprise said processor executing said first processing engine using said data set as input in a simulation mode. When the data set used by the first processing engine changes while the first processing engine is executing in production mode and/or the output generated by the first processing engine is not accessible outside the production environment, the first processing engine needs to execute in simulation mode in order to create the first output. This has as advantage that no production data can be overwritten by accident.

The method may further comprise a step of copying said data set and providing said copy of said data set to said first processing engine and/or said second processing engine. This is beneficial when the original of the data set, i.e. the instance located at the storage location that is used in production mode, may change while a processing engine is using the data set. Any reference to “data set” may refer to the copy of the data set or the original of the data set.

Said first output may be a subset of all output of said first processing engine using said data set as input and said second output may be a corresponding subset of all output of said second processing engine using said data set as input. This may be beneficial when an improvement in the improved processing engine results in part of the output being different. For example, an improved planning algorithm for a package delivery company may produce the same locations to be visited, but may produce different (more optimal) routes.

Said first output may comprise all output of said first processing engine using said data set as input and said second output may comprise all output of said second processing engine using said data set as input. This may be beneficial when an improvement in the improved processing engine does not result in part of the output being different.

Steps a, b and c may be performed a plurality of times and said first processing engine may be replaced with said second processing engine as deployed processing engine in dependence on at least said plurality of comparisons. This may be beneficial when a data set is dynamic and a comparison of outputs generated at one instance is not sufficiently representative. Steps a, b and may be repeated an X number of times with a period Y between repetitions, for example.

According to the invention, the second object is realized in that the system for replacing a processing engine comprises at least one memory for storing a first processing engine and a second processing engine and at least one processor configured to execute said first processing engine using a data set as input, said first processing engine having been deployed, to execute said second processing engine in a simulation mode using said data set as input, to compare first output of said first processing engine using said data set as input with second output of said second processing engine using said data set as input and to replace said first processing engine with said second processing engine as deployed processing engine in dependence on at least said comparison.

Said at least one processor may be configured to execute said first processing engine using said data set as input in a production mode. Said at least one processor may be configured to execute said first processing engine using said data set as input in a simulation mode. Said at least one processor may be configured to copy said data set and to provide said copy of said data set to said first processing engine and/or said second processing engine.

Said first output may be a subset of all output of said first processing engine using said data set as input and said second output may be a corresponding subset of all output of said second processing engine using said data set as input. Said first output may comprise all output of said first processing engine using said data set as input and said second output may comprise all output of said second processing engine using said data set as input.

Said at least one processor may be configured to execute said first processing engine using said data set as input, to execute said second processing engine in said simulation mode using said data set as input and to compare said first output with said second output a plurality of times and said at least one processor may be configured to replace said first processing engine with said second processing engine as deployed processing engine in dependence on at least said plurality of comparisons.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations comprising: executing a first processing engine using a data set as input, said first processing engine having been deployed, executing a second processing engine in a simulation mode using said data set as input, comparing first output of said first processing engine using said data set as input with second output of said second processing engine using said data set as input, and replacing said first processing engine with said second processing engine as deployed processing engine in dependence on at least said comparison.

As will be appreciated by one skilled in the art, aspects of the present invention may be embodied as a system, a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the method of the invention;

FIG. 2 is a flow diagram of a second embodiment of the method of the invention;

FIG. 3 is a flow diagram of a third embodiment of the method of the invention;

FIG. 4 is a block diagram exemplifying the execution of an embodiment of the method of the invention;

FIG. 5 is a block diagram exemplifying the execution of a further embodiment of the method of the invention;

FIG. 6 is a block diagram of a first embodiment of the system of the invention;

FIG. 7 is a block diagram of a second embodiment of the system of the invention;

FIG. 8 is a block diagram of a third embodiment of the system of the invention;

and

FIG. 9 is a block diagram of an exemplary data processing system for performing the method of the invention.

Corresponding elements in the drawings are denoted by the same reference numeral.

### DETAILED DESCRIPTION OF THE DRAWINGS

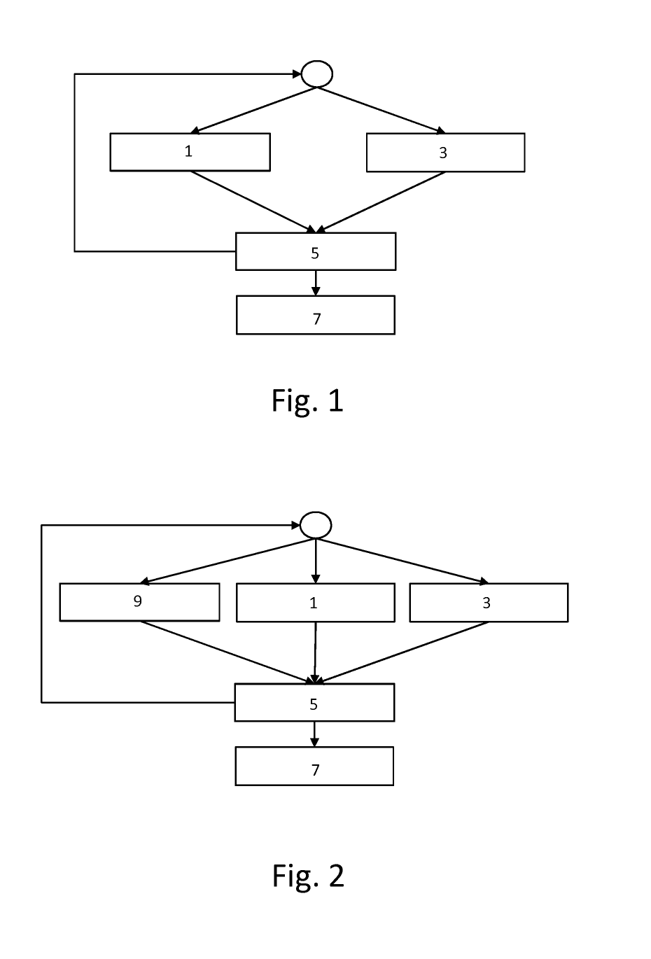

A first embodiment of the method of replacing a processing engine is shown in FIG. 1. A step 1 comprises a processor executing a first processing engine using a data set as input, the first processing engine having been deployed. A step 3 comprises a processor executing a second processing engine in a simulation mode using the data set as input. A step 5 comprises a processor comparing first output of the first processing engine using the data set as input with second output of the second processing engine using the data set as input. A step 7 comprises a processor replacing the first processing engine with the second processing engine as deployed processing engine in dependence on at least the comparison. In FIG. 1, steps 1 and 3 are shown being executed in parallel. Steps 1 and 3 may alternatively be performed in sequence, in any desired order.

In the embodiment shown in FIG. 1, steps 1, 3 and 5 are performed a plurality of times and the first processing engine is replaced with the second processing engine as deployed processing engine in dependence on at least the plurality of comparisons. If it is determined in step 5 that the first processing engine should not be replaced with the second processing engine in the production mode (yet), step 1 and/or step 3 is performed next. In the embodiment shown in FIG. 1, step 1 comprises the processor executing the first processing engine using the data set as input in a production mode.

The first output may be a subset of all output of the first processing engine using the data set as input and the second output maybe a corresponding subset of all output of the second processing engine using the data set as input. Alternatively, the first output may comprise all output of the first processing engine using the data set as input and the second output may comprise all output of the second processing engine using the data set as input.

A second embodiment of the method of replacing a processing engine is shown in FIG. 2. In the second embodiment, step 1 comprises the processor executing the first processing engine using the data set as input in a simulation mode. This is beneficial if the output of the first processing engine running in production mode is not accessible or if the data set that a processing engine uses as input (in production mode) changes while the processing engine processes the data set. A step 9 comprises a processor executing the first processing engine in a production mode using the data set as input or using a different data set as input. The processor executing the first processing engine may be the same as or different than the processor executing the second processing engine. If only a single instance of the first processing engine may run at a time, the first processing engine may be switched from production mode to simulation mode. In that case, steps 1 and 9 are not performed in parallel.

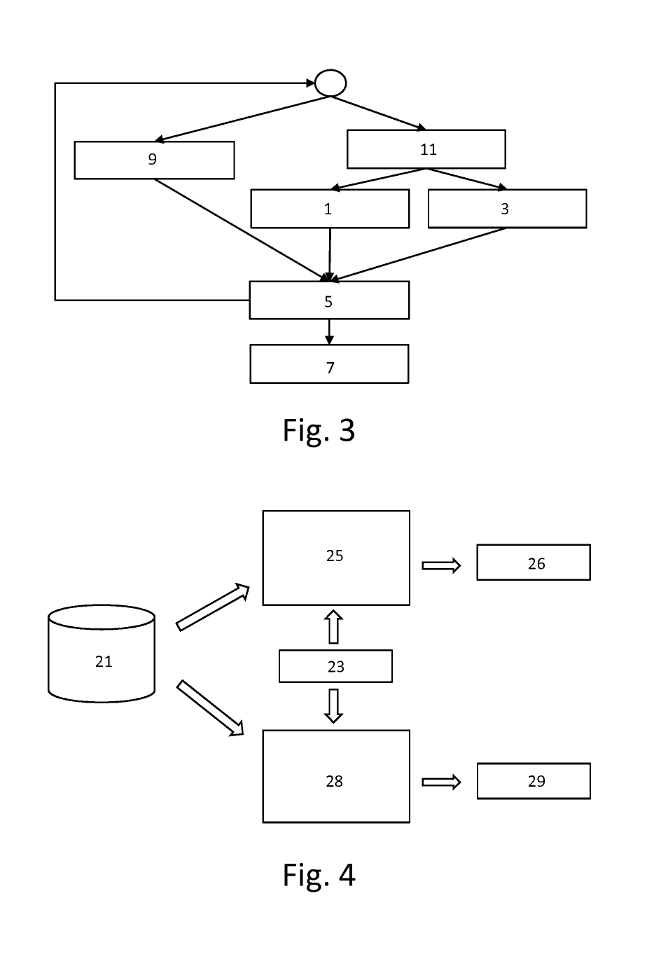

A third embodiment of the method of replacing a processing engine is shown in FIG. 3. In the third embodiment, the method further comprises a step 11 of copying the data set and providing the copy of the data set to the first processing engine and the second processing engine. This is beneficial if the data set that a processing engine uses as input (in production mode) changes while the processing engine processes the data set.

FIG. 4 illustrates the execution of an embodiment of the method of the invention. The first processing engine 25 and the second processing engine 28 both read the original of the data set 21 and both use rules 23. Both the original of the data set 21 and the rules 23 are assumed to be constant. The first processing engine 25 generates output 26 based on the data set 21. The second processing engine 28 generates output 29 based on the data set 21. By running both processing engines side by side, processing the data set 21 through both processing engines, comparing the outputs 26 and 29 and choosing which engine should be “live” (deployed) based on this comparison a fail-safe mechanism for replacing/updating a processing engine is realized.

Either only part, which may be as small as just one number, or all of the outputs of the first processing engine 25 and the processing engine 28 may be compared. This is dependent on the processing engine's, e.g. the expert system's, business domain and may programmed in the comparison logic for that engine/system, e.g. if it cannot be specified in a generic way.

As an example in which only part of the outputs are compared, a data set consists of locations where to pick up packages and a logistics system planning the routes according to regulation (e.g. maximum driver time per driver) and other rules (e.g. max loading weight). Although an improved algorithm might produce different routes (in fact the whole purpose of creating a new algorithm is to optimize the routes) it should end up with the same outcome that all locations are visited and all parcels are collected given current data sets and rules. In this example the routes themselves are not compared.

As an example in which all of the outputs are compared, a data set consists of demographic information about people and a deterministic algorithm which determines for each person in the data set the eligibility for receiving discount as outcome based on some business rules (e.g. a person is eligible if she is the first born female person older than 18 years on a given address). The algorithm in production performs too slow, so a new improved algorithm was developed that should yield the same results (i.e. same people getting a discount) as the previous one given the same data set and business rules.

To determine whether it is ‘safe’ to replace the first processing engine 25 with the second processing engine 28, one of several options may be used, such as: Zero tolerance. The outputs need to match exactly between the two versions. Delta tolerance. The outputs are allowed to differ, but only up to a certain degree (e.g. a percentage or absolute value).

### Interactive.

A screen is presented to the user that shows the differences and the user chooses to continue or abort the upgrade.

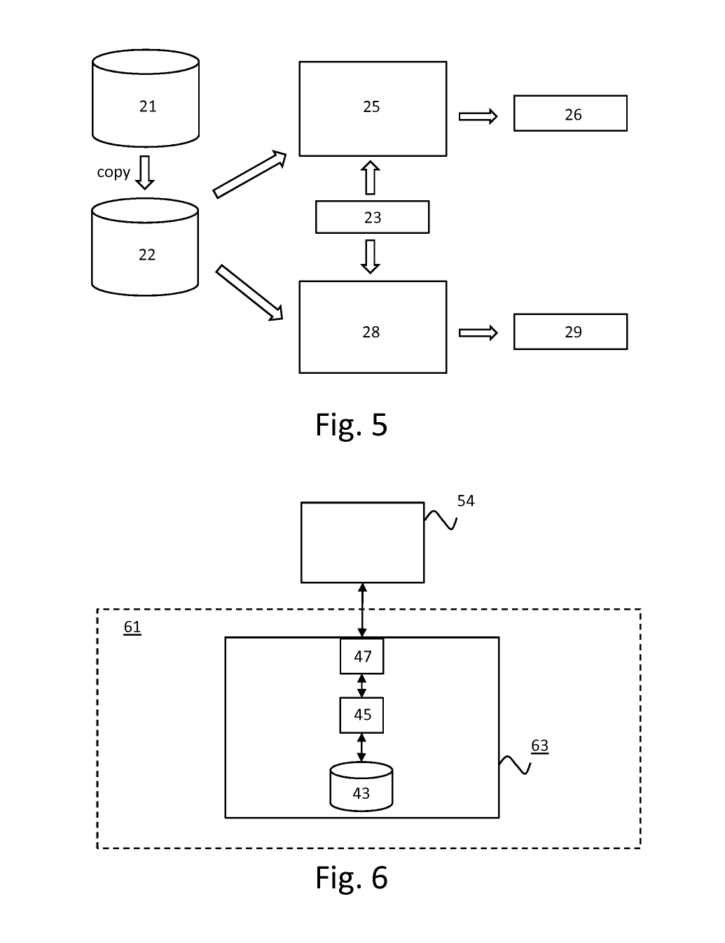

FIG. 5 illustrates the execution of a further embodiment of the method of the invention. Compared to the execution of the embodiment illustrated in FIG. 4, a copy of the original of the data set 21 is made as described in relation to FIG. 3, resulting in copy of the data set 22. This is beneficial when the original of the data set 21 is not constant.

A first embodiment of the system for replacing a processing engine is shown in FIG. 6. The system 61 comprises a server 63. The server 63 comprises a memory 43 for storing a first processing engine and a second processing engine and a processor 45. The processor 45 is configured to execute the first processing engine using a data set as input, the first processing engine having been deployed. The processor 45 is further configured to execute the second processing engine in a simulation mode using the data set as input. The processor 45 is further configured to compare first output of the first processing engine using the data set as input with second output of the second processing engine using the data set as input. The processor 45 is further configured to replace the first processing engine with the second processing engine as deployed processing engine in dependence on at least the comparison.

In this embodiment, a management console 54 is used by a user to initiate the process of replacing a processing engine and the management console 54 transmits data to an input/output interface 47 of the server 63 in order to configure the server 63. If the second processing engine is not already present on server 63, the management console 54 may transmit the second processing engine to the input/output interface 47 of the server 63 or inform the server 63 where it may be able to obtain the second processing engine. The management console 54 may comprise a workstation, for example.

The server 63 and/or the management console 54 may run a Windows and/or Unix (or Unix-like) operating system, for example. The processor 45 may comprise an Intel or AMD processor, for example. The memory 43 may comprise multiple memory components. The memory 43 may comprise a solid-state (e.g. RAM or flash), optical and/or magnetic memory, for example. In the embodiments of FIGS. 6 to 8, an input interface and an output interface are combined in a single component, e.g. a transceiver. Alternatively, the input interface and the output interface may be separate components. The input/output interface 47 may be wired (e.g. Ethernet) and/or wireless (e.g. WiFi/IEEE 802.11) network interfaces, for example. The management console 54 may be similar to the server 63 and additionally comprise one or more interfaces for interacting with a user, e.g. a display and a keyboard. In an alternative embodiment, the function of the management console 54 may be performed on/by the server 63.

If the output of the first processing engine running in production mode is not accessible or the data set that the first processing engine uses as input changes while the processing engine processes the data set, the processor 45 may need to execute the first processing engine in simulation mode. If the data set that the first processing engine uses as input changes while the processing engine processes the data set, the processor 45 may need to make a copy of the data set and both the first processing engine and the second processing engine may read the copy of the data set instead of the original of the data set. If the data set does not change, both the first processing engine and the second processing engine may read the original of the data set. If the processor 45 executes the first processing engine in simulation mode and the first processing engine does not execute in production mode on server 63, the original of the data set is likely not stored in memory 43. In the first embodiment, the original and/or copy of the data set and the outputs of the first and second processing engines may be stored in the memory 43. Alternatively, these data may be stored in one or more memories outside the server 63.

When the first output of the first processing engine and the second output of the second processing engine are determined to be sufficiently similar, the processor 45 may replace the first processing engine with the second processing engine as deployed processing engine. Since typically no two processing engines are allowed to run in production mode at the same time, a third component, may be needed to decommission the first processing engine and deploy the second processing engine. This third component may be associated with the second processing engine. This is beneficial as the criteria for determining whether it is ‘safe’ to replace the first processing engine with the second processing engine are typically defined during development of the second processing engine. These criteria may include information that specifies which output of the two processing engines should be compared.

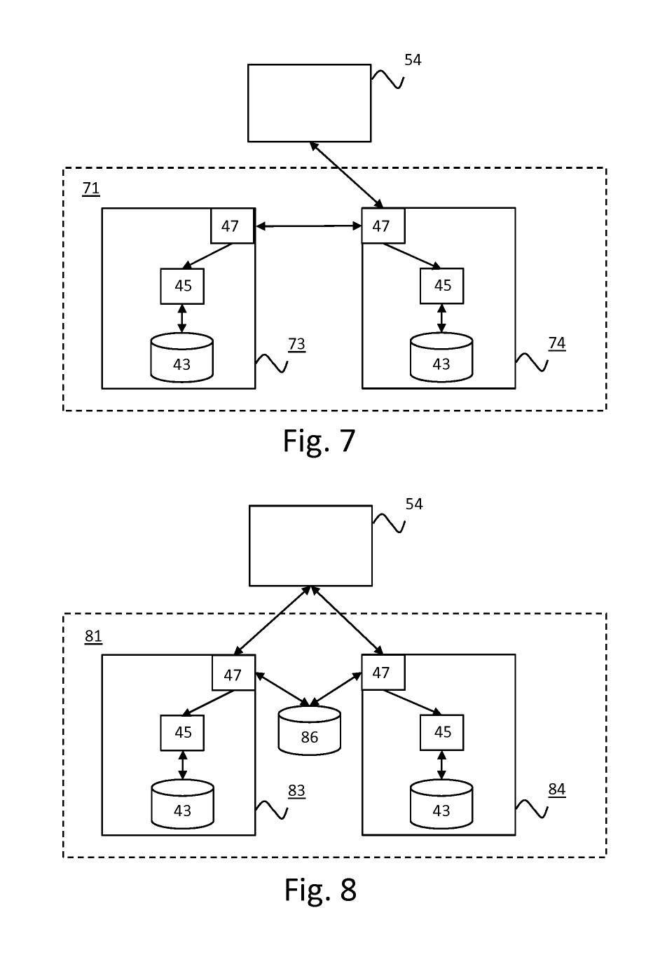

A second embodiment of the system for replacing a processing engine is shown in FIG. 7. The system 71 comprises a first server 73 and a second server 74 In the second embodiment, the first server 73 and the second server 74 are similar to the server 63 described in relation to FIG. 6. The processor 45 of the first server 73 executes the first processing engine. The processor 45 of the second server 74 executes the second processing engine.

In the second embodiment, the management console 54 is used by a user to initiate the process of replacing a processing engine and the management console transmits data to the input/output interface 47 of the server 74 in order to configure the server 74. If the second processing engine is not already present on server 74, the management console 54 may transmit the second processing engine to the input/output interface 47 of the server 74 or inform the server 74 where it may be able to obtain the second processing engine. In the second embodiment, the server 74 subsequently contacts the server 73.

If the output of the first processing engine running in production mode is not accessible or the data set that the first processing engine uses as input changes while the processing engine processes the data set, the processor 45 of server 73 may need to execute the first processing engine in simulation mode. If the data set that the first processing engine uses as input changes while the processing engine processes the data set, the processor 45 may need to make a copy of the data set and both the first processing engine and the second processing engine may read the copy of the data set instead of the original of the data set. In this case, the second processing engine executing on server 74 may read a copy of the data set stored in the memory 43 of server 73 or may obtain the data set from server 73 and store it in memory 43 of server 74 from where it can be read by the second processing engine, for example.

When the first output of the first processing engine and the second output of the second processing engine are determined to be sufficiently similar, the second processing engine replaces the first processing engine as deployed processing engine. The second processing engine may be copied to server 73 and the processor 45 of server 73 may start executing the second processing engine in production mode instead of the first processing engine, for example. Alternatively, the server 74 may become the production server and the processor 45 of server 74 may start executing the second processing engine already present on server 74 in production mode, for example. In the latter example, the processor 45 of server 73 will not or no longer execute a processing engine in production mode.

A third embodiment of the system for replacing a processing engine is shown in FIG. 8. Compared to the second embodiment shown in FIG. 7, the original of the data set used by the first processing engine running in production mode is now stored in storage means 86. Furthermore, it is now the management console 54 instead of the server 84 that communicates with the server 83. In an alternative embodiment, only one of these two aspects is different. The storage means 86 may comprise multiple storage components. The storage means 86 may comprise a solid-state (e.g. RAM or flash), optical and/or magnetic storage means, for example.

If the output of the first processing engine running in production mode is not accessible or the data set that the first processing engine uses as input changes while the processing engine processes the data set, the processor 45 of server 83 may need to execute the first processing engine in simulation mode. The management console 54 then transmits instructions to input/output interface 47 of server 83 to run the first processing engine in simulation mode. If the data set that the first processing engine uses as input changes while the processing engine processes the data set, the processor 45 may need to make a copy of the data set and both the first processing engine and the second processing engine may read the copy of the data set instead of the original of the data set. In this case, the copy of the data set may be stored on storage means 86 as well and/or may be stored on memory 45 of server 83 and/or server 84, for example.

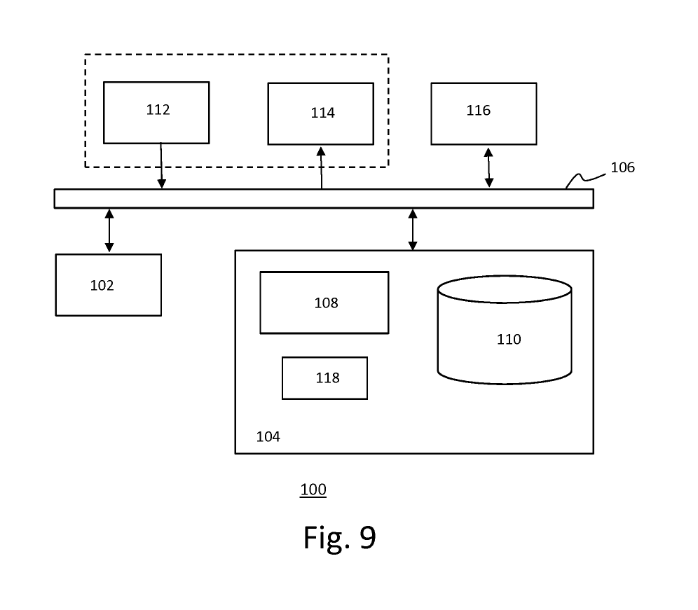

FIG. 9 depicts a block diagram illustrating an exemplary data processing system that may perform the methods as described with reference to FIGS. 1 to 3.

As shown in FIG. 9, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 9, the memory elements 104 may store an application 118. In various embodiments, the application 118 may be stored in the local memory 108, the one or more bulk storage devices 110, or separate from the local memory and the bulk storage devices. It should be appreciated that the data processing system 100 may further execute an operating system (not shown in FIG. 9) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method of replacing a processing engine, comprising the steps of:
a) a processor executing a first processing engine using a data set as input, said first processing engine having been deployed;
b) a processor executing a second processing engine in a simulation mode using said data set as input;
c) a processor comparing first output of said first processing engine using said data set as input with second output of said second processing engine using said data set as input; and
d) a processor replacing said first processing engine with said second processing engine as deployed processing engine in dependence on at least said comparison.

2. The method of claim 1, wherein step a) comprises said processor executing said first processing engine using said data set as input in a production mode.

3. The method of claim 1, wherein step a) comprises said processor executing said first processing engine using said data set as input in a simulation mode.

4. The method of claim 1, further comprising a step of copying said data set and providing said copy of said data set to said first processing engine and/or said second processing engine.

5. The method of claim 1, wherein said first output is a subset of all output of said first processing engine using said data set as input and said second output is a corresponding subset of all output of said second processing engine using said data set as input.

6. The method of claim 1, wherein said first output comprises all output of said first processing engine using said data set as input and said second output comprises all output of said second processing engine using said data set as input.

7. The method of claim 1, wherein said steps a, b and c are performed a plurality of times and said first processing engine is replaced with said second processing engine as deployed processing engine in dependence on at least said plurality of comparisons.

8. (canceled)

9. A system for replacing a processing engine, comprising:
at least one memory for storing a first processing engine and a second processing engine; and
at least one processor configured to execute said first processing engine using a data set as input, said first processing engine having been deployed, to execute said second processing engine in a simulation mode using said data set as input, to compare first output of said first processing engine using said data set as input with second output of said second processing engine using said data set as input and to replace said first processing engine with said second processing engine as deployed processing engine in dependence on at least said comparison.

10. The method of claim 9, wherein said at least one processor is configured to execute said first processing engine using said data set as input in a production mode.

11. The method of claim 9, wherein said at least one processor is configured to execute said first processing engine using said data set as input in a simulation mode.

12. The method of claim 9, wherein said at least one processor is configured to copy said data set and to provide said copy of said data set to said first processing engine and/or said second processing engine.

13. The method of claim 9, wherein said first output is a subset of all output of said first processing engine using said data set as input and said second output is a corresponding subset of all output of said second processing engine using said data set as input.

14. The method of claim 9, wherein said first output comprises all output of said first processing engine using said data set as input and said second output comprises all output of said second processing engine using said data set as input.

15. The method of claim 9, wherein said at least one processor is configured to execute said first processing engine using said data set as input, to execute said second processing engine in said simulation mode using said data set as input and to compare said first output with said second output a plurality of times and said at least one processor is configured to replace said first processing engine with said second processing engine as deployed processing engine in dependence on at least said plurality of comparisons.
